(19) United States
(12) Patent Application Publication
(10) Pub. No.: US 2014/0078136 A1
(43) Pub. Date: Mar. 20, 2014

(54) APPARATUS AND METHOD FOR SYNTHESIZING INTERMEDIATE VIEW IMAGE, RECORDING MEDIUM THEREOF

(71) Applicant: INDUSTRY-ACADEMIC COOPERATION FOUNDATION, YONSEI UNIVERSITY, Seoul (KR)

(72) Inventors: Kwang-Hoon Sohn, Seoul (KR); Bum Sub Ham, Seoul (KR)

(73) Assignee: Industry-Academic Cooperation Foundation, Yonsei University, Seoul (KR)

(21) Appl. No.: 13/886,849

(22) Filed: May 3, 2013

(30) Foreign Application Priority Data
Sep. 18, 2012 (KR) 10-2012-0103251

(51) Int. Cl. G06T 15/00

(52) U.S. Cl. CPC G06T 15/00
USPC 345/419

(57) ABSTRACT

Disclosed are an apparatus and method for synthesizing an intermediate view image and a recording medium thereof. The disclosed apparatus for synthesizing an intermediate view image may include: a probability information generating part configured to generate information related to a matching probability between a first image and a second image; and a synthesizing part configured to synthesize an intermediate view image by applying a weight according to the matching probability to the first image and second image. Certain embodiments of the invention provide the advantage of enabling enhanced image quality when synthesizing an intermediate view image without requiring post-processing operations such as for processing occlusions and for filling holes.

### CROSS-REFERENCE TO RELATED APPLICATIONS

This application claims the benefit of Korean Patent Application No. 10-2012-0103251, filed on Sep. 18, 2012, the disclosure of which is incorporated herein by reference in its entirety.

### TECHNICAL FIELD

Embodiments of the present invention relate to an apparatus and method for synthesizing an intermediate view image and a recording medium thereof, more particularly to an apparatus and method for synthesizing an intermediate view image and a recording medium thereof which can enhance image quality when synthesizing an intermediate view image without requiring post-processing operations such as for processing occlusions and for filling holes.

### DESCRIPTION OF THE RELATED ART

Image-based rendering techniques are for generating an image from an arbitrary viewpoint by using several 2-dimensional images from different viewpoints.

Among such techniques, view interpolation uses given images to synthesize a new image from a view between the viewpoints of the given images, based on a depth map and geometric information.

There have been many approaches to improve the performance of view interpolation. However, the performance of most methods largely depends on the quality of the geometric information, i.e. depth maps, since incorrect geometric information causes pixels to be located at incorrect positions.

Furthermore, the rendered view has holes to be filled due to discrete sampling, incorrect depth information, and occlusion.

To resolve the problems above, warping-based rendering was recently proposed, which is motivated by image retargeting. The image rendered by warping-based rendering does not suffer from the hole filing problem, since the warping process is defined in a continuous manner.

However, a discretization error may occur, and there may also be geometric distortion, especially at the line structures, due to the nature of the warping process.

Similar to image-based rendering techniques, warping-based rendering techniques also require exact depth information, as the quality of a rendered image depends greatly on the quality of the depth map. Thus, a large amount of depth information is needed, and if there is sparse depth information, a relatively larger number of input images may be required.

Thus, improving the quality of a rendered image essentially requires an increase in the amount of data, and if there is only a small amount of data, post-processing operations such as for processing occluded portions or filling holes may be required.

### SUMMARY

An aspect of the invention is to provide an apparatus and method for synthesizing an intermediate view image and a recording medium thereof which can enhance image quality when synthesizing an intermediate view image without requiring post-processing operations such as for processing occlusions and for filling holes.

One aspect of the invention provides an apparatus for synthesizing an intermediate view image that includes: a probability information generating part configured to generate information related to a matching probability between a first image and a second image; and a synthesizing part configured to synthesize an intermediate view image by applying a weight according to the matching probability to the first image and second image.

The probability information generating part can include: a first probability information generating part configured to generate first probability information related to a probability of the second image matching the first image from a perspective of the first image; and a second probability information generating part configured to generate second probability information related to a probability of the first image matching the second image from a perspective of the second image.

The apparatus can further include: a first virtual image generating part configured to generate a first virtual image based on first disparity information of the second image from a perspective of the first image; and a second virtual image generating part configured to generate a second virtual image based on second disparity information of the first image from a perspective of the second image, where the synthesizing part can synthesize the intermediate view image by applying a weight on the first virtual image according to the first probability information and applying a weight on the second virtual image according to the second probability information.

The synthesizing part can synthesize the intermediate view image by interpolating the first virtual image and the second virtual image to which the weights are applied.

The first probability information generating part can move the second image by a pixel unit within a particular movement range and generate the first probability information whenever there is a movement, while the first virtual image generating part can generate the first virtual image using a movement distance of the second image as the first disparity information whenever there is a movement of the second image.

The second probability information generating part can move the first image by a pixel unit within a particular movement range and generate the second probability information whenever there is a movement, and the second virtual image generating part can generate the second virtual image using a movement distance of the first image as the second disparity information whenever there is a movement of the first image.

The movement range of the second image can be substantially equal to the movement range of the first image, while the movement direction of the second image can be substantially opposite to the movement direction of the first image.

The synthesizing part can synthesize the intermediate view image by interpolating the first virtual image and the second virtual image generated whenever there is a movement, synthesizing the intermediate view image with a weighted average using the first probability information and the second probability information as weights.

Another embodiment of the invention provides a method for synthesizing an intermediate view image that includes: generating information related to a matching probability between a first image and a second image; and synthesizing an intermediate view image by applying a weight according to the matching probability to the first image and second image.

Yet another embodiment of the invention provides a recorded medium readable by a computer that tangibly embodies a program of instructions executable by the computer to perform the method for synthesizing an intermediate view image.

Certain embodiments of the invention provide the advantage of enabling enhanced image quality when synthesizing an intermediate view image without requiring post-processing operations such as for processing occlusions and for filling holes.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a flowchart illustrating a process for synthesizing an intermediate view image typically used in depth-image-based rendering (DIBR).

FIG. 2 is a block diagram illustrating the composition of an apparatus for synthesizing an intermediate view image according to an embodiment of the invention.

FIG. 3 is a flowchart illustrating a method for synthesizing an intermediate view image according to an embodiment of the invention.

FIG. 4 illustrates matching points for cases in which a point to be filled in for an intermediate view image can be obtained from a left image.

FIG. 5 illustrates matching points for cases in which a point to be filled in for an intermediate view image cannot be obtained from a left image, i.e. is a hole.

FIG. 6 illustrates intermediate view images synthesized according to an embodiment of the invention, in comparison with intermediate view images synthesized according to depth-image-based rendering, for various aggregation window sizes.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals are used for like elements.

Certain embodiments of the invention will be described below in more detail with reference to the accompanying drawings.

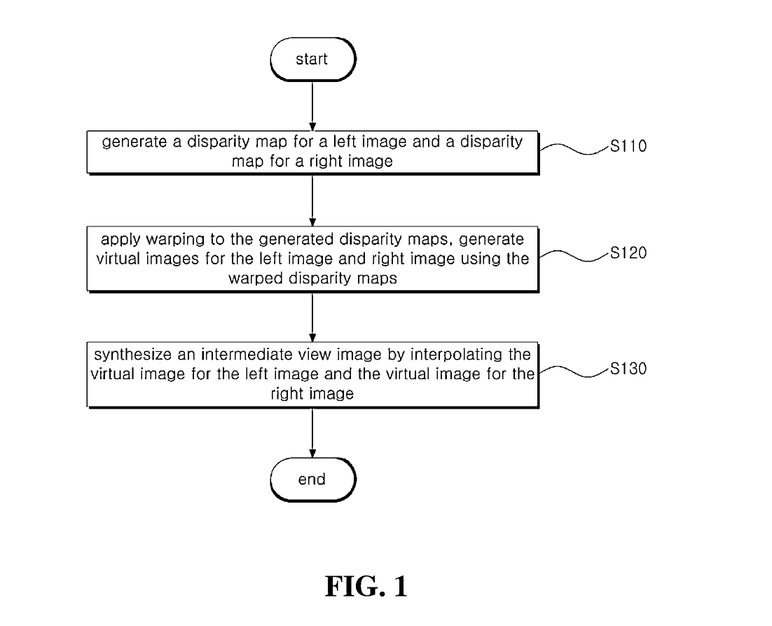

FIG. 1 is a flowchart illustrating a process for synthesizing an intermediate view image typically used in depth-image-based rendering (DIBR).

As illustrated in FIG. 1, a process for synthesizing an intermediate view image may include generating a disparity map (S110), generating a virtual image (S120), and synthesizing an intermediate view image (S130).

First, in step S110, the disparity map for a left image and the disparity map for a right image may be generated.

Assuming that TAD's (truncated absolute differences) are used, the energy of each pixel can be computed as follows, using the differences between the left image and the right image that is moved by d, to generate the disparity map for the left image.

eₗ(m,d)=min(|Iₗ(x,y)−Iᵣ(x−d,y)|,σ) [Equation 1]

Here, m represents the space coordinates (x, y) of an image, Iₗ represents the left image, Iᵣ represents the right image, d represents the disparity of each pixel, σ represents the threshold, and eₗ represents the energy of each pixel in the left image.

By using a local method or a global method to optimize the energy eₗ(m, d) computed as above, the optimized energy Eₗ(m, d) of each pixel can be calculated.

Continuing with the description, a winner-take-all (WTA) approach can be applied to the optimized energy, to generate a disparity map for each pixel of the left image as in the equation shown below.

$${d}_{l} ( m ) = {argmin}_{d ∈ [ 0 , … , D - 1 ]} {E}_{l} ( m , d ) \qquad [ Equation 2 ]$$

Here, dₗ(m) represents the disparity map for the left image, and D represents the search range.

By performing the above process in the same manner, the disparity map for the right image can be generated as well. In this case, as the disparity of the left image and the disparity of the right image are opposite to each other, the signs of d may preferably be opposite.

That is, in step S110, the energy of each pixel can be computed as follows, and an optimization procedure and WTA approach can be applied, to generate the disparity map for each pixel of the right image.

$${e}_{r} ( m , d ) = min ( \vert {I}_{l} ( x + d , y ) - {I}_{r} ( x , y ) \vert , σ ) \\ {d}_{r} ( m ) = {argmin}_{d ∈ [ 0 , … , D - 1 ]} {E}_{r} ( m , d ) \qquad [ Equation 3 ]$$

Next, in step S120, warping may be applied to the disparity map generated in step S110, and virtual images may be generated for the left image and right image by using the warped disparity map.

To be more specific, in step S120, a warping process may be performed on the disparity maps dₗ(m) and dᵣ(m) generated in step S110 by using the position β where an intermediate view image is to be synthesized, to thereby generate disparity maps, i.e. −dₗ*(m) and dᵣ*(m), corresponding to the virtual viewpoint.

Supposing that the position of the left image is 0 and the position of the right image is 1, β is the position for which the intermediate view image is to be synthesized and has a value of 0≦β≦1.

The virtual image Iₗᵥ(m) synthesized from the left image and the virtual image Iᵣᵥ(m) synthesized from the right image may be generated using dₗ*(m) and dᵣ*(m), according to the equations shown below.

Iₗᵥ(m)=(1−wₗ)Iₗ(└x+βd*ₗ(m)┘,y)+wₗIₗ(└x+βd*ₗ(m)┘+1,y)

wₗ=(x+βd*ₗ(m))−└x+βd*ₗ(m)┘ [Equation 4]

Iᵣᵥ(m)=(1−wᵣ)Iᵣ(└x−(1−β)d*ᵣ(m)┘,y)+wᵣIᵣ(└x−(1−β)d*ᵣ(m)┘+1,y)

wᵣ=(x−(1−β)d*ᵣ(m))−└x−(1−β)d*ᵣ(m)┘ [Equation 5]

Continuing with the description, in step S130, the intermediate view image may be synthesized by interpolating the virtual image for the left image and the virtual image for the right image according to the equation shown below.

Iᵥ(m)=βIₗᵥ(m)+(1−β)Iᵣᵥ(m) [Equation 6]

As already described above, the intermediate view image synthesized according to these steps (S110 to S130) is based on geometric information such as disparity maps. Because of this characteristic, any inaccuracy in the geometric information can result in erroneous positioning of pixels.

Moreover, the intermediate view image synthesized as above may include holes caused by discrete sampling, inaccurate depth information, or occlusions, etc., and may require large amounts of data to resolve such problems.

Utilizing the fact that the energy of each pixel can be converted to a Gibbs distribution, the inventors propose a method for synthesizing an intermediate view image using probability.

According to an aspect of the invention, an intermediate view image can be efficiently synthesized even with a small amount of geometric information and input images, and can have an enhanced picture quality even if there is no post-processing applied for processing occlusions or filling holes.

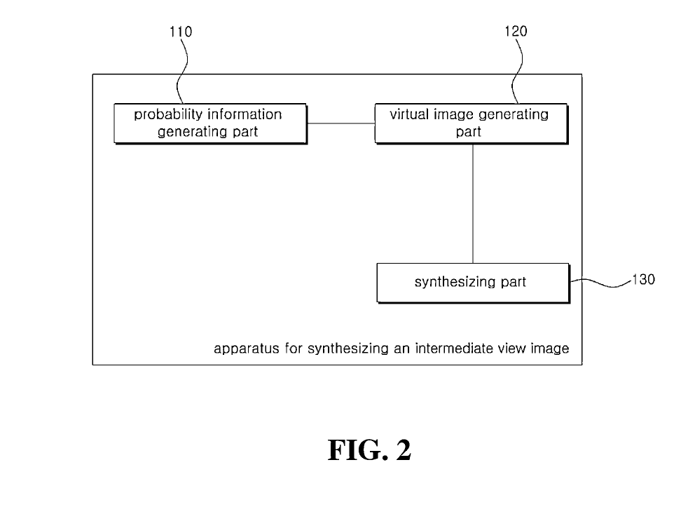

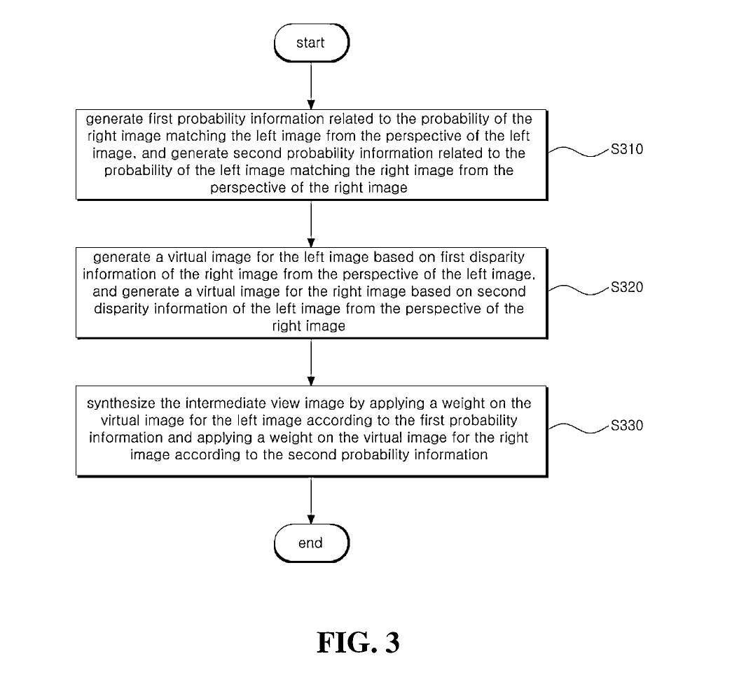

FIG. 2 is a block diagram illustrating the composition of an apparatus 100 for synthesizing an intermediate view image according to an embodiment of the invention, and FIG. 3 is a flowchart illustrating a method for synthesizing an intermediate view image according to an embodiment of the invention.

As illustrated in FIG. 2 and FIG. 3, an apparatus 100 for synthesizing an intermediate view image can include a probability information generating part 110, a virtual image generating part 120, and a synthesizing part 130, while a method for synthesizing an intermediate view image can include generating probability information (S310), generating virtual images (S320), and synthesizing an intermediate view image (S330).

A more detailed description is provided below, with reference to FIG. 2 and FIG. 3, of the operations by which an apparatus 100 for synthesizing an intermediate view image according to an embodiment of the invention synthesizes an image for an intermediate viewpoint from the left image and right image of a stereo image (i.e. a method for synthesizing an intermediate view image).

First, in step S310, the probability information generating part 110 may generate first probability information, which is related to the probability of the right image matching the left image from the perspective of the left image, and second probability information, which is related to the probability of the left image matching the right image from the perspective of the right image.

Generating the information related to matching probability can be performed unidirectionally, but performing the generating bidirectionally as in an embodiment of the invention can encompass the processing of occlusions in the image and also improve the reliability of the intermediate view image synthesized from the matching probability.

According to an embodiment of the invention, the probability information generating part 110 can generate the probability information according to the equation shown below.

pₗ(m,d)=max(σ−|Iₗ(x,y)−Iᵣ(x−d,y)|,0) [Equation 7]

Here, pₗ represents the probability of the left image matching the right image that is moved by d (i.e. the first probability information), m represents the space coordinates (x, y) of an image, Iₗ represents the left image, Iᵣ represents the right image, d represents the disparity of each pixel, and σ represents the threshold.

Equation 7 above corresponds to an equation for generating the first probability information from the perspective of the left image, but since the disparity of the left image and the disparity of the right image are opposite to each other as described above, the sign of d can be inverted to also generate the second probability information.

The first probability information and second probability information generated in step S310 can be optimized by a local method or a global method to generate the optimized probabilities Pₗ(m, d) and Pᵣ(m, d) for each pixel.

Also, since Pₗ(m, d) includes the probability of the left image Iₗ(x, y) matching the right image Iᵣ(x, y) that is moved by d, it is possible to generate a disparity map by computing the equation below, contrary to the case described above for depth-image-based rendering (DIBR).

$${d}_{l} ( m ) = {argmax}_{d ∈ [ 0 , … , D - 1 ]} {P}_{l} ( m , d )$$

However, based on the fact that Pₗ(m, d) includes the probability of the left image Iₗ(x, y) matching the right image Iᵣ(x, y) that is moved by d, the image for an intermediate viewpoint may be synthesized as described below using Pₗ(m, d).

According to an embodiment of the invention, the generating of the first probability information by the probability information generating part 110 can involve moving the right image by a pixel unit within a particular movement range and generating the first probability information whenever there is a movement.

Similarly, the generating of the second probability information by the probability information generating part 110 can involve moving the left image by a pixel unit within a particular movement range and generating the second probability information whenever there is a movement.

Here, since the disparity of the right image is opposite to that of the left image, the movement ranges of the left image and right image may be substantially equal, while the movement directions may be opposite to each other.

This will be described later on in more detail.

Next, in step S320, the virtual image generating part 120 may generate a virtual image for the left image, based on first disparity information of the right image from the perspective of the left image, and may generate a virtual image for the right image, based on second disparity information of the left image from the perspective of the right image.

As shown in Equation 4 and Equation 5 above, the virtual images for synthesizing the intermediate view image may in general be generated by the WTA (winner-take-all) approach of Equation 2.

That is, from among various disparity information, the disparity information that minimizes the energy may be selected, and the virtual images may be generated from the left image and the right image, respectively, by using the selected disparity information.

However, an embodiment of the invention may generate the virtual images without applying the WTA approach, but instead by using all of the various disparity information, based on the fact that Pₗ(m, d) includes the matching probability of the left image Iₗ(x, y) and the right image Iᵣ(x, y) that is moved by d (or, Pᵣ(m, d) includes the matching probability of the right image Iᵣ(x, y) and the left image Iₗ(x, y) that is moved by d), where the matching probability for each of the virtual images generated may be reflected as a weight in synthesizing the image of an intermediate viewpoint.

To be more specific, when the probability information generating part 110 moves the right image by a pixel unit within a particular movement range and generates the first probability information whenever there is a movement, the virtual image generating part 120 according to an embodiment of the invention may generate a virtual image for the left image, using the movement distance of the right image, i.e. the number of pixels moved, as the first disparity information, every time the right image is moved.

According to an embodiment of the invention, the virtual image generating part 120 can generate the virtual image for the left image according to the equation below.

Iₗᵥ(m,k)=(1−wₗ)Iₗ(└x+βk┘,y)+wₗIₗ(└x+βk┘+1,y)

wₗ=(x+βk)−└x+βk┘ [Equation 8]

Here, Iₗᵥ(m, k) represents the virtual image for the left image, k represents the movement distance of the right image (k is an integer greater than or equal to 0), and β represents the position for which the intermediate view image is to be synthesized (β has a value of 0≦β≦1).

That is, the virtual image generating part 120 can generate the virtual image for the left image with the movement distance k of the right image as the first disparity information according to Equation 8.

Similarly, when the probability information generating part 110 moves the left image by a pixel unit within a particular movement range and generates the second probability information whenever there is a movement, the virtual image generating part 120 according to an embodiment of the invention may generate a virtual image for the right image, using the movement distance of the left image as the second disparity information, every time the left image is moved.

According to an embodiment of the invention, the virtual image generating part 120 can generate a virtual image for the right image according to the equation shown below.

Iᵣᵥ(m,k)=(1−wᵣ)Iᵣ(└x−(1−β)k┘,y)+wᵣIᵣ(└x−(1−β)k┘+1,y)

wᵣ=(x−(1−β)k)−└x−(1−β)k┘ [Equation 9]

Here, Iᵣᵥ(m, k) represents the virtual image for the right image, k represents the movement distance of the left image (k is an integer greater than or equal to 0). The movement distance k of the right image in Equation 8 and the movement distance k of the left image may preferably be the same.

Continuing with the description, in step S330, the synthesizing part 130 may synthesize the intermediate view image by applying a weight to the virtual image for the left image according to the first probability information and applying a weight to the virtual image for the right image according to the second probability information.

As described above, the probability information generating part 110 may move the left image and right image in pixel units and may generate the first probability information and second probability information every time there is a movement, while the virtual image generating part 120 may also generate a virtual image for each image every time there is a movement of the respective image. Thus, the synthesizing part 130 may also synthesize an intermediate view image by applying weights to the virtual images according to the probability information every time each image is moved.

Here, the synthesizing part 130 according to an embodiment of the invention can synthesize the intermediate view image by interpolating the virtual image for the left image and the virtual image for the right image that are generated whenever there is a movement. The intermediate view image can be synthesized with a weighted average using the first probability information and second probability information generated for every movement as weights.

Instead of selecting one set of disparity information as is the case in depth-image-based rendering, this weight-averaging process uses all of the disparity information, before one set of disparity information is selected, in generating the virtual images, thus corresponding to synthesizing an image of an intermediate viewpoint by reflecting the matching probability for each of the generated virtual images. Accordingly, even when there is an insufficient amount of data (depth information or input images, etc.), a high-quality intermediate view image can be synthesized based only on mathematical computations.

According to an embodiment of the invention, the synthesizing part 130 can synthesize an intermediate view image according to the equation below.

$${I}_{v} ( m ) = {\sum }_{k = 0}^{D - 1} \frac{\begin{matrix}β {I}_{lv} ( x , y , k ) {P}_{l} ( {x}^{*} , y , k ) + \\ ( 1 - β ) {I}_{rv} ( x , y , k ) {P}_{r} ( {x}^{**} , y , k )\end{matrix}}{β {P}_{l} ( {x}^{*} , y , k ) + ( 1 - β ) P ( {x}^{**} , y , k )} \\ {x}^{*} = round ( x + β k ) \\ {x}^{**} = round ( x - ( 1 - β ) k ) \qquad [ Equation 10 ]$$

Here, Iᵥ(m) represents the intermediate view image, and round represents rounding to nearest.

In other words, the synthesizing part 130 may synthesize the intermediate view image by linearly interpolating the two generated virtual images, where, assuming that the right image is moved by k from the perspective of the left image, the matching probability Pₗ (x*, y, k) is applied as a weight to the virtual image Iₗᵥ(x, y, k) at that time, and assuming that the left image is moved by k from the perspective of the right image, the matching probability Pᵣ(x*, y, k) is applied as a weight to the virtual image Iᵣᵥ(x, y, k) at that time, so that the intermediate view image is synthesized with a weighted average.

This process for synthesizing an intermediate view image according to an embodiment of the invention can be regarded as a generalized form of the process for synthesizing an intermediate view image based on depth-image-based rendering.

For example, if only the disparity information having the highest probability is retained and the other probabilities are set to 0, such as:

$${P}_{l} ( {x}^{*} , y , k ) = \{ \begin{matrix}1 & k = {d}_{l}^{*} \\ 0 & k \neq {d}_{l}^{*}\end{matrix}$$

then it can be seen that Equation 10 according to an embodiment of the invention is made equal to Equation 6 for DIBR.

Thus, according to an embodiment of the invention, the intermediate view image may be synthesized based on probability, so that one of the problems encountered while generating a depth map, i.e. intermediate image error caused by a local minimum, can be distributed, and the quality of the generated image can be improved compared to conventional methods.

Also, since the intermediate view image may be synthesized based on all disparity information and its corresponding probabilities, there is no need for post-processing such as hole filling, and since the processing for occlusions is already included in the rendering process in a probabilistic manner, there is no further need for processing occlusions.

A description is provided below of the feature regarding the rendering process including the processing for occlusions. Here, it is assumed that the background texture of the image varies smoothly.

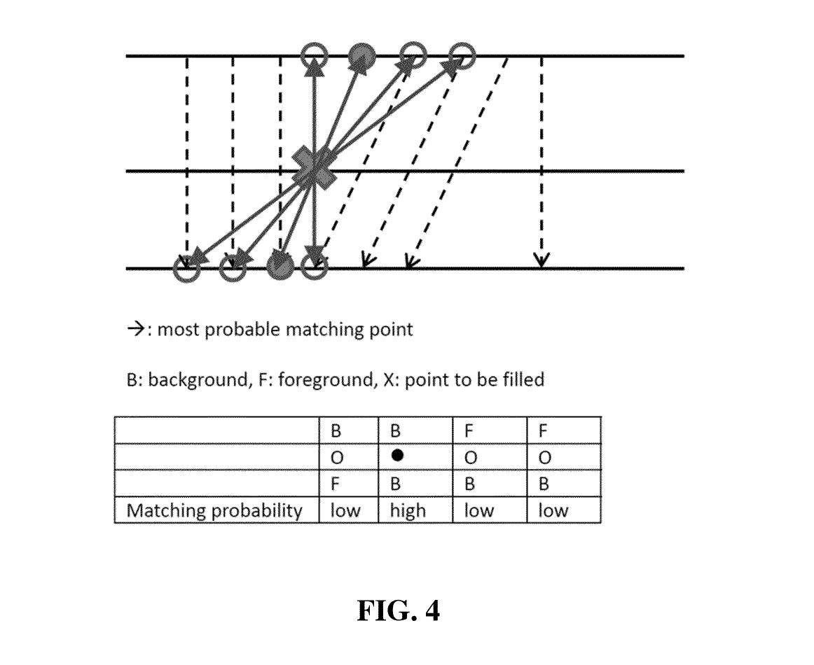

FIG. 4 illustrates matching points for cases in which a point to be filled in for an intermediate view image can be obtained from a left image. In FIG. 4, it can be seen that, even when there is no processing for an occluded portion in the left image, the correct point • is defined for the point X that is to be filled.

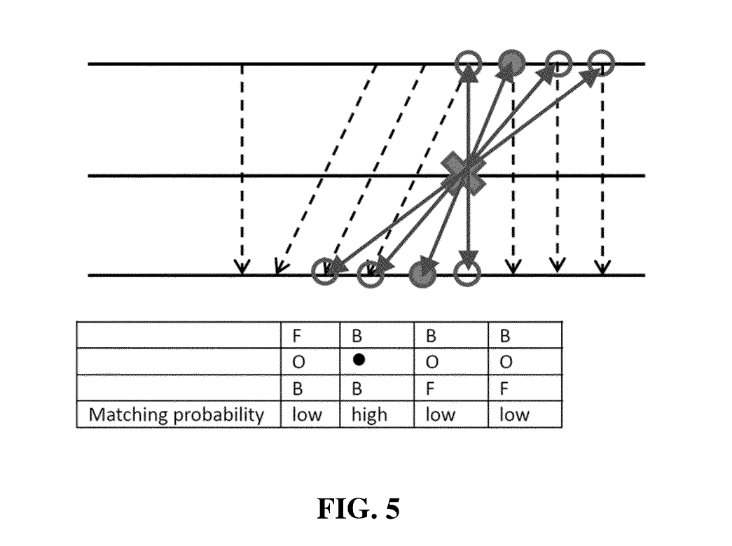

FIG. 5 illustrates matching points for cases in which a point to be filled in for an intermediate view image cannot be obtained from a left image, i.e. is a hole. In FIG. 5, it can be seen that the background texture of the left image is rendered even when it is not a correct texture.

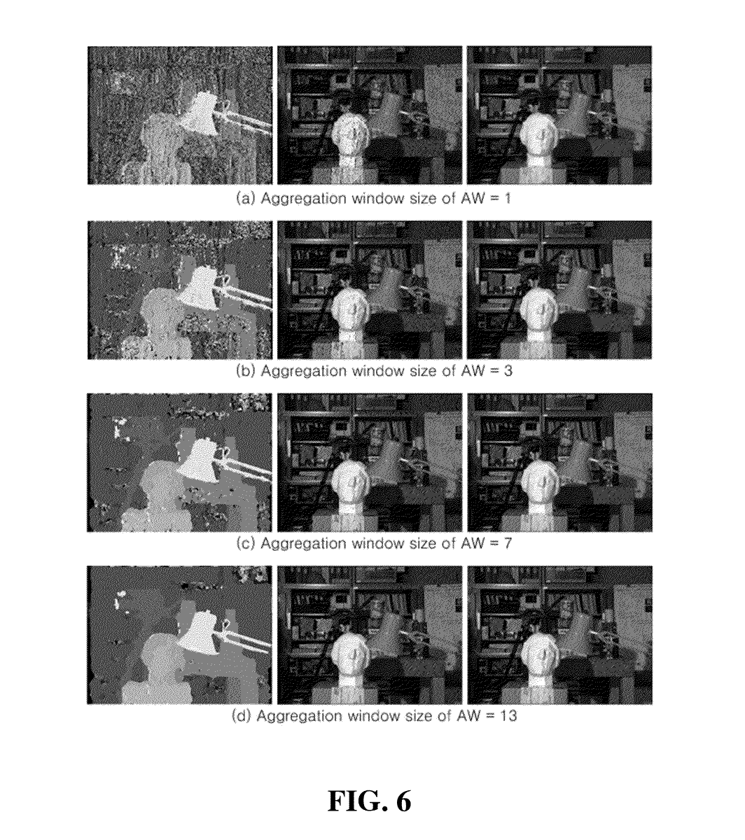

FIG. 6 illustrates intermediate view images synthesized according to an embodiment of the invention, in comparison with intermediate view images synthesized according to depth-image-based rendering, for various aggregation window sizes.

FIG. 6 shows, from left to right, a depth map, an intermediate view image synthesized by DIBR, and an intermediate view image synthesized according to an embodiment of the invention, for each aggregation window size.

As illustrated in FIG. 6, according to certain embodiments of the invention, a sharper intermediate view image can be obtained even without post-processing. Furthermore, the embodiments do not require large amounts of data, so that there is no need for a memory element such as the Z-buffer used in depth-image-based rendering (DIBR). Also, since the processing for occluded potions is inherently included in the rendering process, there is no need for separate processing of occlusions.

The embodiments of the present invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

While the present invention has been described above using particular examples, including specific elements, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains. Therefore, the spirit of the present invention must not be limited to the embodiments described herein, and the scope of the present invention must be regarded as encompassing not only the claims set forth below, but also their equivalents and variations.

What is claimed is:

1. An apparatus for synthesizing an intermediate view image, the apparatus comprising:
a probability information generating part configured to generate information related to a matching probability between a first image and a second image; and
a synthesizing part configured to synthesize an intermediate view image by applying a weight according to the matching probability to the first image and second image.

2. The apparatus of claim 1, wherein the probability information generating part comprises:
a first probability information generating part configured to generate first probability information related to a probability of the second image matching the first image from a perspective of the first image; and
a second probability information generating part configured to generate second probability information related to a probability of the first image matching the second image from a perspective of the second image.

3. The apparatus of claim 2, further comprising:
a first virtual image generating part configured to generate a first virtual image based on first disparity information of the second image from a perspective of the first image; and
a second virtual image generating part configured to generate a second virtual image based on second disparity information of the first image from a perspective of the second image,
wherein the synthesizing part synthesizes the intermediate view image by applying a weight on the first virtual image according to the first probability information and applying a weight on the second virtual image according to the second probability information.

4. The apparatus of claim 3, wherein the synthesizing part synthesizes the intermediate view image by interpolating the first virtual image and the second virtual image having the weights applied thereto.

5. The apparatus of claim 3, wherein the first probability information generating part moves the second image by a pixel unit within a particular movement range and generates the first probability information whenever there is a movement,
and the first virtual image generating part generates the first virtual image using a movement distance of the second image as the first disparity information whenever there is a movement of the second image.

6. The apparatus of claim 5, wherein the second probability information generating part moves the first image by a pixel unit within a particular movement range and generates the second probability information whenever there is a movement,
and the second virtual image generating part generates the second virtual image using a movement distance of the first image as the second disparity information whenever there is a movement of the first image.

7. The apparatus of claim 6, wherein the movement range of the second image is substantially equal to the movement range of the first image, and a movement direction of the second image is substantially opposite to a movement direction of the first image.

8. The apparatus of claim 6, wherein the synthesizing part synthesizes the intermediate view image by interpolating the first virtual image and the second virtual image generated whenever there is a movement, the synthesizing part synthesizing the intermediate view image with a weighted average using the first probability information and the second probability information as weights.

9. A method for synthesizing an intermediate view image, the method comprising:
generating information related to a matching probability between a first image and a second image; and
synthesizing an intermediate view image by applying a weight according to the matching probability to the first image and second image.

10. The method of claim 9, wherein generating the probability information comprises:
generating first probability information related to a probability of the second image matching the first image from a perspective of the first image; and
generating second probability information related to a probability of the first image matching the second image from a perspective of the second image.

11. The method of claim 10, further comprising:
generating a first virtual image based on first disparity information of the second image from a perspective of the first image; and
generating a second virtual image based on second disparity information of the first image from a perspective of the second image,
wherein the synthesizing comprises:
synthesizing the intermediate view image by applying a weight on the first virtual image according to the first probability information and applying a weight on the second virtual image according to the second probability information.

12. The method of claim 11, wherein generating the first probability information comprises:
moving the second image by a pixel unit within a particular movement range and generating the first probability information whenever there is a movement,
and generating the first virtual image comprises generating the first virtual image using a movement distance of the second image as the first disparity information whenever there is a movement of the second image.

13. The method of claim 12, wherein generating the second probability information comprises:
moving the first image by a pixel unit within a particular movement range and generating the second probability information whenever there is a movement,
and generating the second virtual image comprises generating the second virtual image using a movement distance of the first image as the second disparity information whenever there is a movement of the first image.

14. The method of claim 13, wherein the synthesizing comprises:
synthesizing the intermediate view image by interpolating the first virtual image and the second virtual image generated whenever there is a movement, synthesizing the intermediate view image with a weighted average using the first probability information and the second probability information as weights.

15. A recorded medium readable by a computer, tangibly embodying a program of instructions executable by the computer to perform the method for synthesizing an intermediate view image according to claim 9.
